(19) United States
(12) Patent Application Publication
(10) Pub. No.: US 2012/0313945 A1
(43) Pub. Date: Dec. 13, 2012

(54) SYSTEM AND METHOD FOR ADDING A CREATIVE ELEMENT TO MEDIA

(75) Inventors: David Canora, Winter Garden, FL (US); Robert A. Swirsky, Sunnyvale, CA (US)

(73) Assignee: DISNEY ENTERPRISES, INC. A DELAWARE CORPORATION, Burbank, CA (US)

(21) Appl. No.: 13/158,887

(22) Filed: Jun. 13, 2011

(51) Int. Cl. G06T 15/60

(52) U.S. Cl. 345/426

(57) ABSTRACT

A system for adding a creative element to media includes a media file having content and metadata associated with the content, logic for analyzing the content to determine at least one of a lighting characteristic, a shadow characteristic, and a presence of an identifying element associated with the content. The system also includes a creative element store configured to store at least one creative element, a rendering engine configured to develop a three dimensional rendering of the creative element, the three dimensional rendering including at least one of the lighting characteristic and the shadow characteristic, and a compositor configured to add the three dimensional rendering of the creative element into the content based on the metadata.

### BACKGROUND

The availability and use of digital media continues to increase. Examples of digital media include digital image files, digital video files, digital audio files, and a number of other types of media. One of the benefits of digital media, such as a digital image file, is the ease with which the digital image file can be stored and manipulated. For example, it is common to electronically store, transfer, access and view a digital image file using, for example, a computer or other viewing device or appliance.

One of the areas in which the use of digital media has expanded is in the entertainment industry, particularly in the amusement park area. In many entertainment events and venues attendees often have pictures taken to memorialize their experience at the event. As an example, attendees at an amusement park will often take pictures at the park. Further, at many entertainment venues, photographers mingle with attendees offering to take pictures of the attendees. Using a photograph taken by a photographer at an amusement park as an example, the image captured by the photographer can be manipulated in some way prior to being made available to the subject of the photograph. For example, the captured image can be placed on or associated with a feature or theme of the amusement park, or particular amusement associated with the attraction in which the image was captured.

Typically, the manipulation of the captured image is done manually by an individual prior to the captured image being made available to the attendee. However, it would be desirable to have a way of automatically manipulating the captured image using automatic techniques that can use at least portions of the image content as an input to the manipulation.

### SUMMARY

Embodiments of a system for adding a creative element to media include a media file having content and metadata associated with the content, logic for analyzing the content to determine at least one of a lighting characteristic, a shadow characteristic, and a presence of an identifying element associated with the content. The system also includes a creative element store configured to store at least one creative element, a rendering engine configured to develop a three dimensional rendering of the creative element, the three dimensional rendering including at least one of the lighting characteristic and the shadow characteristic, and a compositor configured to add the three dimensional rendering of the creative element into the content based on the metadata.

Other embodiments are also provided. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views.

FIG. 1 is a block diagram illustrating an example of a system for adding a creative element to media.

FIG. 2 is a schematic diagram illustrating an example of the output of the marker detection module of FIG. 1.

FIG. 3 is a schematic diagram illustrating an example of how the output from the light analysis module and the shadow analysis module of FIG. 1 can be used to place a virtual camera and light source for rendering a 3D object to be included in the scene.

FIG. 4 is a schematic diagram illustrating an example view from the virtual camera of FIG. 3.

FIGS. 5A through 5C are schematic diagrams illustrating an example of the location of a virtual camera based on a first detected marker.

FIGS. 6A through 6C are schematic diagrams illustrating an example of the location of a virtual camera based on a second detected marker.

FIGS. 7A and 7B collectively are a flowchart describing the operation of an embodiment of the creative element addition system of FIG. 1.

FIGS. 8A through 8D collectively illustrate a graphical example of the system and method for adding a creative element to media.

### DETAILED DESCRIPTION

The system and method for adding a creative element to media can be implemented to add elements to any electronic media that includes content that is visible to an individual, and will be described in the context of adding one or more creative elements to a digital image file. The system and method for adding a creative element to media can be implemented in hardware, software, or a combination of hardware and software. When the system and method for adding a creative element to media is implemented in software, the software can be used to process a digital media file and add one or more creative elements to the digital media file. The software can be stored in a memory and executed by a suitable instruction execution system (microprocessor). The hardware implementation of the system and method for adding a creative element to media can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), etc.

The software for the system and method for adding a creative element to media comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

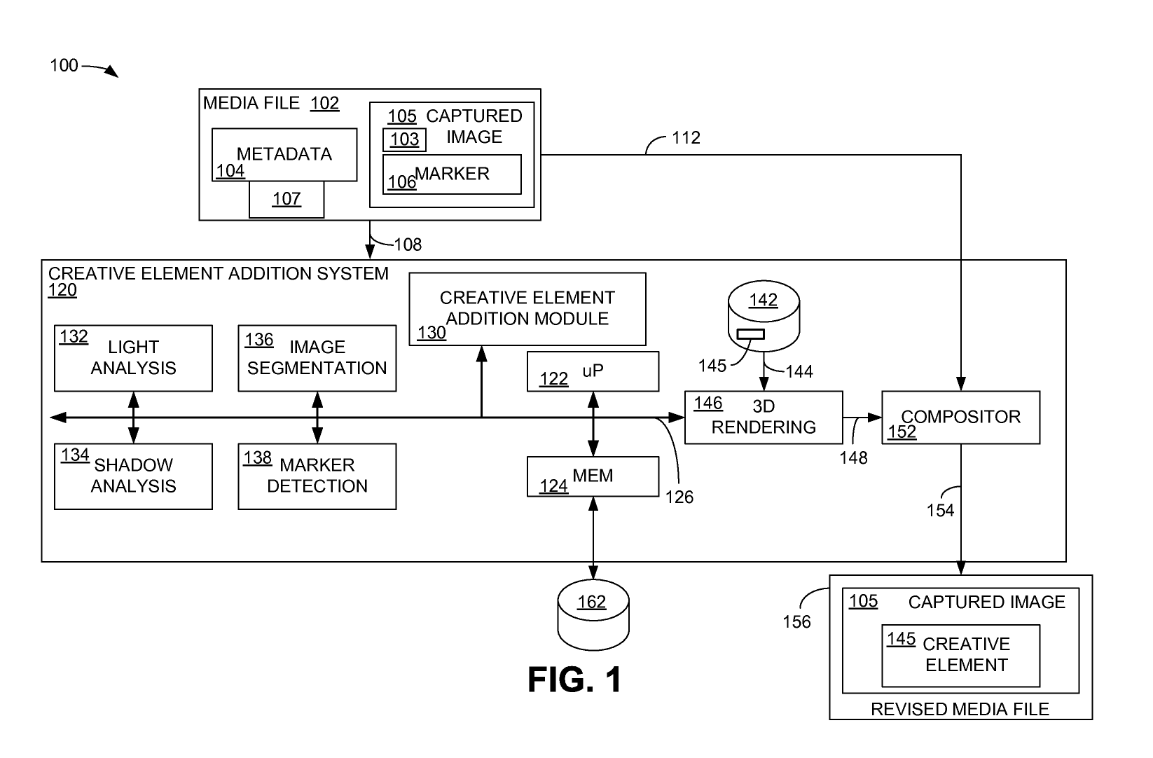

FIG. 1 is a block diagram illustrating an embodiment of a system for adding a creative element to media. The system 100 includes a media file 102, which in this embodiment is an example of media to which a creative element may be added. In an embodiment, the media file 102 can include content such as a digital photograph, which is embodied as a captured image 105. Alternatively, the media file 102 may include captured video, or other media content, to which a creative element may be added. If the media file 102 comprises video, the media file 102 would be treated on a frame-by-frame basis and the captured image 105 can comprise a single video frame. In an embodiment, the media file 102 includes metadata 104 that can be associated with the captured image 105. Often, data in addition to the media content is appended to, prepended to, prefixed to, stored with, or otherwise associated with the media content. This additional data is generally referred to as “metadata.” As a basic example, the date and time that an image is captured is often associated with a captured image. The date and time information is stored in the media file 102 as metadata 104 along with the file of the captured image 105. Alternatively, the metadata can be stored in a database that can be associated with the media content without being part of the media content. Metadata provides information relating to and about the media content in addition to the media content itself Other examples of metadata include, but are not limited to, the global positioning system (GPS) coordinates of the location at which the image is captured, and positional information, such as compass direction of the subject in the captured image. At least some of this additional metadata can be applied to the media content by the device that captures the image. For example, many digital cameras can provide such metadata when capturing the media content.

The media file 102 may also include a unique identifier 107 that identifies a subject 103 (e.g., a person) in the captured image 105. The unique identifier 107 can be stored with the media file 102, but is a pointer to metadata 104 about the subject 103. The unique identifier 107 can be used to identify the subject 103 and can also include additional information about the subject 103. The additional information can be used in addition to previously described metadata 104 to determine which creative element to add to the captured image 105. For example, if the unique identifier 107 indicates that the subject 103 is celebrating a birthday, the creative element chosen may have a birthday theme; for example, a character wearing a birthday hat. Other examples include determining which creative element to add to the captured image 105 based on season, special event, the time of day, known preferences of the subject 103, etc.

The captured image 105 also includes a marker 106. The marker 106 can be an electronically identifiable visible element located in the scene that is photographed to generate the captured image 105, or can be an electronically identifiable visible element inserted into the scene by an individual before the scene is photographed to generate the captured image 105, or otherwise associated with the media file 102. The metadata 104 identifies the marker 106 from a set of possible markers stored in a database 162. For example, if the marker 106 in the captured image 105 is a manhole cover, then only metadata 104 referring to objects that are shaped like “manhole covers” and/or another element that can be interpreted as a “generally circular” object that may appear in the captured image 105, or that a photographer may have placed in the scene prior to image capture, is analyzed. Further, other distinguishing characteristics of the marker 106, such as color, geometric pattern, or any combination of visually identifiable characteristics, can be used to identify the marker 106.

The description herein refers to adding a creative element to the captured image 105. However, the system and method for adding a creative element to media is not so limited. The system and method for adding a creative element to media can be used to add a creative element to any media file 102.

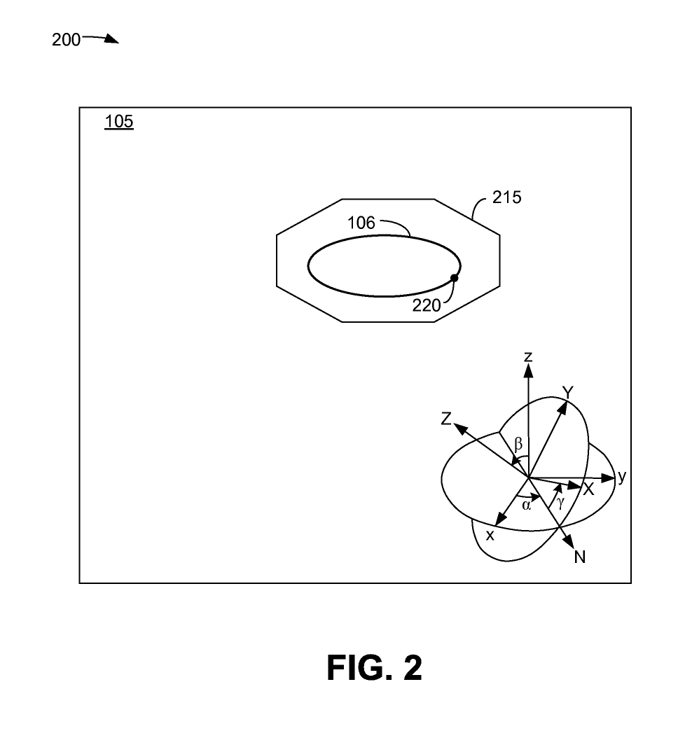

The system 100 also includes a creative element addition system 120. The creative element addition system 120 generally includes a creative element addition module 130, a light analysis module 132, a shadow analysis module 134, an image segmentation module 136, a marker detection module 138 a processor 122, memory 124, and a three-dimensional (3D) rendering engine 146, coupled together over a system bus 126. The system bus 126 can be any combination of a physical and logical communication bus over which the coupled elements can bi-directionally communicate. The description of the light analysis module 132, shadow analysis module 134, image segmentation module 136, and marker detection module 138 will periodically refer to FIGS. 2 through 6C.

FIG. 2 is a schematic diagram illustrating an example of the information conveyed in the output of the marker detection module 138 of FIG. 1, and FIG. 3 is a schematic diagram illustrating an example of how the output from the light analysis module 132 and the shadow analysis module 134 of FIG. 1 can be used to place a virtual camera and light source for rendering of the 3D object to be included in the scene so that the 3D object appears to have lighting and shadow characteristics similar to a subject in the scene.

The marker detection module 138 receives as input the captured image 105 and uses a commercially available pattern-matching and feature detection algorithm to identify a marker 106 within the image. The marker detection module 138 provides as output the identity of the detected marker, and a bounding polygon 215 defining the area within the captured image 105 showing the approximate location of the marker 106. In an embodiment, the orientation of the marker 106 can be detected on the three axes, x, y, and z, as shown in FIG. 2.

The Euler notation for describing rotations, as known in the art, is one of a number of systems that can be used to represent the spatial orientation of a coordinate system as a composition of rotations from a frame of reference associated with the coordinate system. As shown in FIG. 2, the fixed system is denoted in lower case letters (x,y,z) and the rotated system is denoted in upper case letters (X,Y,Z). Given a reference frame and the frame whose orientation is to be described, a line of nodes (N) is defined as the intersection of the xy and the XY coordinate planes, where the line of nodes (N) is a line perpendicular to both the z and the Z axes. The Euler angles can then be defined as:

α (or φ) is the angle between the x-axis and the line of nodes (N),

β (or θ) is the angle between the z-axis and the Z-axis, and

γ (or Ψ) is the angle between the line of nodes (N) and the X-axis.

As an example, the point 220 on the marker 106 can indicate the orientation of the marker 106 as a degree (α) of rotation around the z, i.e., the vertical, axis.

FIG. 3 is a schematic diagram illustrating an example of how the output from the light analysis module and the shadow analysis module of FIG. 1 can be used to place a virtual camera and light source for rendering the 3D object to be included in the scene so that the 3D object appears to have lighting and shadow characteristics similar to a subject in the scene. The light analysis module 132 comprises a software module that receives as input the media file 102, the bounding polygon 215 that locates the marker 106 in the captured image 105, and the identity of the located marker 106. The light analysis module 132 outputs a location 310 on a hemisphere 305, which is shown schematically in FIG. 3. The location 310 illustrates a location where the effects of an illumination point source 312 can be applied when rendering the 3D object of the creative element 145 (FIG. 1) that is to be placed within the captured image 105 (FIG. 1).

The shadow analysis module 134 comprises a software module that receives as input the media file 102, the bounding polygon 215 that locates the marker 106 in the captured image 105, and the identity of the located marker 106. The shadow analysis module 134 outputs the location 310 on the hemisphere 305. The location 310 illustrates a location where the effects of the illumination point source 312 can be applied when rendering the 3D object of the creative element 145 (FIG. 1) that is to be placed within the scene in the captured image 105 (FIG. 1).

The hemisphere 305 can be visualized as being an “infinite” distance away from the subject 103, stretching from horizon to horizon. The illumination point source 312 can be visualized as the sun. The objective is to have the rendered 3D object of the creative element 145 (not shown) be illuminated the same way and therefore have the same lighting and cast the same shadow as the subject 103.

If the time of day the photo was taken, the geographic location of the subject 103, and the direction that the subject 103 (or the photographer) is facing are known, then the position of the sun relative to the subject 103 can be determined by one of a number of known astronomical calculations. If such information is not known, then it is possible to use one of several known algorithms to deduce the location of shadows and the light in the scene so that the rendered 3D object of the creative element 145 (not shown) can be illuminated similarly to the subject 103 to achieve maximum realism in the rendered scene.

A virtual camera 314 is located from a perspective that allows it to simulate an image of the rendered 3D object. A virtual camera 314 can be visualized as a point at which an observer might view the subject 103. The virtual camera 314 is a known concept in 3D rendering. The position and the characteristics, for example, the focal length and the aperture, of the virtual camera 314 determine the appearance of the rendered 3D image of the creative element 145. The objective is to render a 3D representation of the creative element 145 in a 2D image from an angle and elevation that corresponds to the angle and elevation of the subject 103 from the perspective of the virtual camera 314 so that the appearance of the rendered 3D object of the creative element 145 matches the appearance of the subject 103.

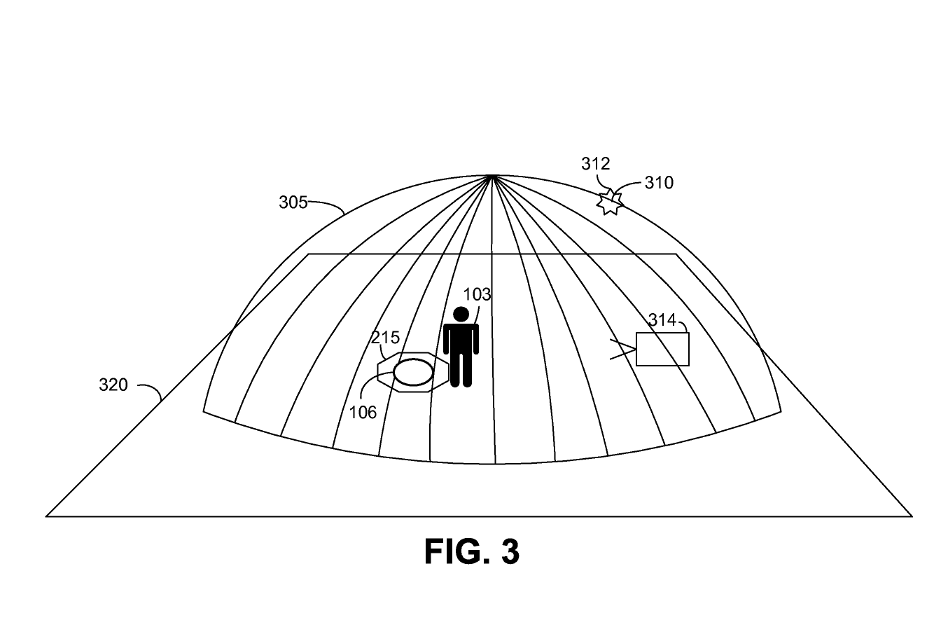

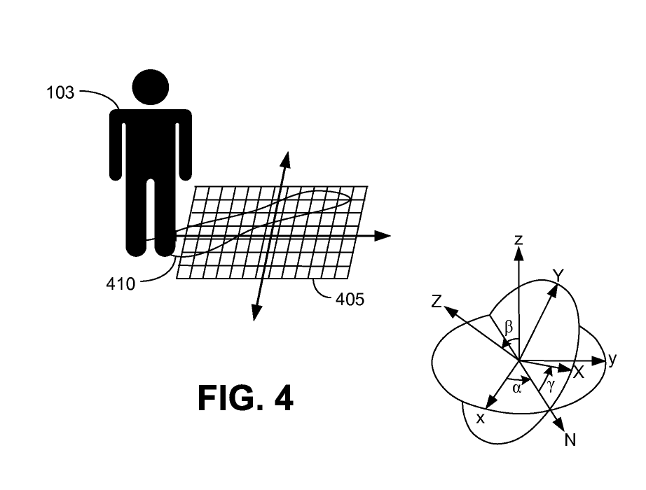

FIG. 4 is a schematic diagram illustrating an example view from the virtual camera of FIG. 3. The virtual camera 314 (FIG. 3) is positioned based on the detected position and orientation of the marker 106 in the scene (FIG. 3), as defined by α, β, and γ, as defined above. This arrangement differs from other virtual reality systems that use markers in which the camera is fixed. The view from the virtual camera 314 includes the subject 103 and a shadow 410 cast by the subject 103 based on the location (310, FIG. 3) of the illumination point source 312 (FIG. 3).

The light analysis module 132 and the shadow analysis module 134 receive the same inputs and produce the same outputs, but they use different methods. The light analysis module 132 identifies areas in the captured image 105 that are receiving extra illumination. The shadow analysis module 134 identifies areas of the captured image 105 that are receiving less illumination. The results of either or both can be used, depending on the confidence of the analysis.

Further, the light analysis module 132 and the shadow analysis module 134 can take an additional input: an image file of the marker 106 under even illumination, with no shadows or highlights. This additional input can help determine which areas of the marker 106 in the captured image 105 might be receiving extra illumination and what areas might be receiving less illumination.

Alternatively, metadata comprising the geographic location of the subject when the content was captured and the time of day that the content was captured can be used to determine the lighting applied to the three-dimensional rendering of the creative element.

The image segmentation module 136 determines the 3D structure of the scene depicted in the captured image 105. The image segmentation module 136 receives as input an output of the marker detection module 138 and the original captured image 105. The image segmentation module 136 makes certain assumptions based on the usage defined for the marker 106. For example, if the marker 106 is apparently located on the ground in the captured image 105, the image segmentation module 136 assumes the plane 320 (FIG. 3) that the marker 106 is on is the ground. If the marker 106 is intended for a vertical surface, the image segmentation module 136 assumes the marker 106 is located on a plane that is perpendicular to the ground.

In this example, when the marker 106 is detected, it is known that the marker is located on the ground and therefore defines the plane 320 (FIG. 3) on which the “ground” in the image is located. The marker 106 is processed as if it exists in 3-dimensional space, with the plane 320 being located in the x-y plane. The virtual camera 314 will be positioned relative to this ground plane 320 in the 3D environment. The virtual camera 314 will be angled so that it will match the roll (axes that protrudes through the center of the lens) and the pitch. The yaw (“heading”) of the virtual camera will always be positioned to be pointed at the rendered object.

In this example, the rendered creative element 145 will be positioned flat (with no rotations on any axis) on the marker 106 and will face the virtual camera 314. Since the marker 106 defines the ground plane 320, it will be flat on the ground. As mentioned above, it is the virtual camera 314 that is positioned, not the rendered creative element 145, which is located on the marker 106 facing the virtual camera 314.

Once the plane 320 is identified as the ground surface, a “shadow” plane 405 (FIG. 4) is created when rendering the 3D creative element 145 that is to be inserted into the scene. When the 3D creative element is rendered, the shadow plane 405 is inserted into the 3D scene and positioned where the ground plane 320 in the 2D image was determined to be located. The shadow plane 405 is not visible in the rendering, but forms a surface upon which a shadow can be rendered. The shadow plane 405 is composited to the ground surface in the original 2D image so that a shadow cast by the 3D object appears to be an integral part of the captured image 105.

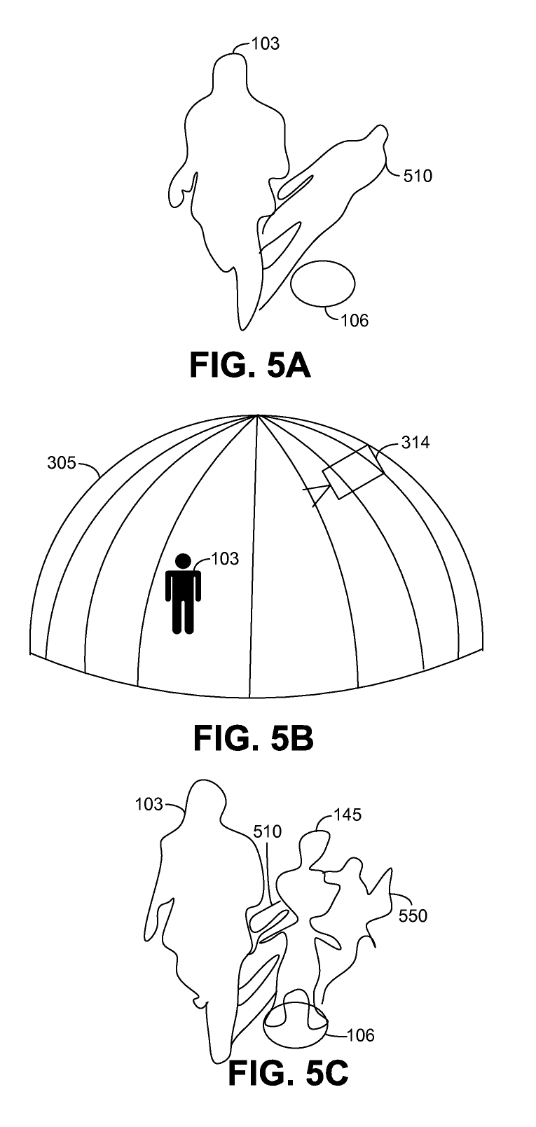

FIGS. 5A through 5C are schematic diagrams illustrating an example of the location of a virtual camera based on a first detected marker. The position of the virtual camera 314 can be determined by the location and appearance of the detected marker 106. The orientation of the detected marker 106 can be inferred based on how its dimensions are skewed from a reference marker. For example, in FIG. 5A, the marker 106 appears to have a particular shape. Based on the appearance of the detected marker 106, the virtual camera 314 is located as shown in FIG. 5B relative to the subject 103 so that a similarly placed representation of the marker 106 has the same shape. In FIG. 5C, the rendered creative element 145 is then composited into the original 2D scene so as to have the same orientation and appearance as the subject 103. A shadow 550 of the rendered creative element 145 is added to the scene to match the shadow 510 cast by the subject 103.

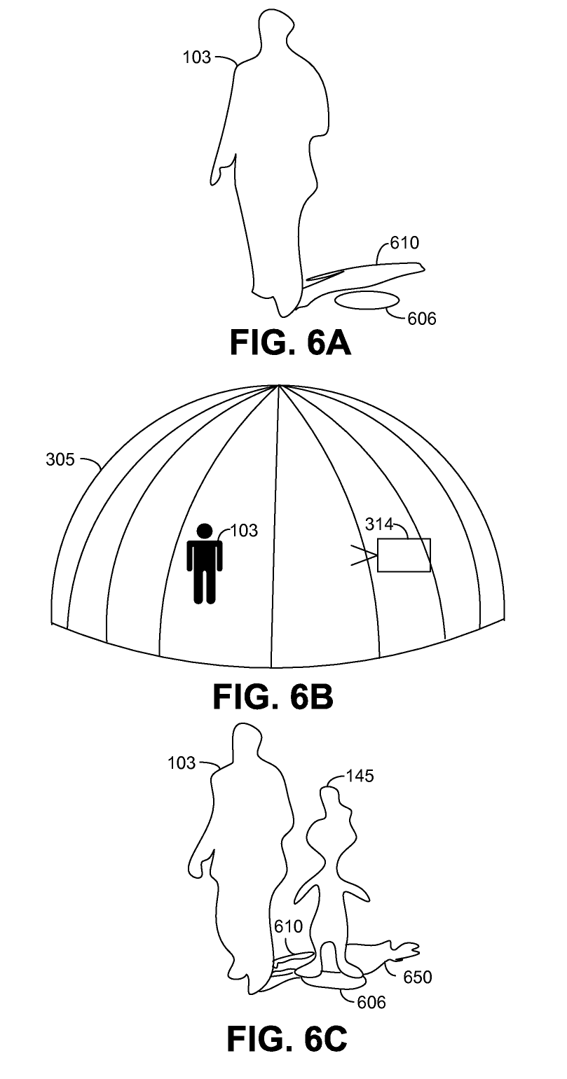

FIGS. 6A through 6C are schematic diagrams illustrating an example of the location of a virtual camera based on a second detected marker. The second detected marker 606 has a shape that is different than the shape of the marker 106 shown in FIGS. 5A and 5C. The position of the virtual camera 314 can be determined by the location and appearance of the detected marker 606. The orientation of the detected marker 606 can be inferred based on how its dimensions are skewed from a reference marker. For example, in FIG. 6A, the marker 606 appears to have a particular shape that is different from the shape of the marker 106 in FIGS. 5A. Based on the appearance of the detected marker 606, the virtual camera 314 is located as shown in FIG. 6B relative to the subject 103 so that a similarly placed representation of the marker 606 has the same shape. In FIG. 6C, the rendered creative element 145 is then composited into the original 2D scene so as to have the same orientation and appearance as the subject 103. A shadow 650 of the rendered creative element 145 is added to the scene to match the shadow 610 cast by the subject 103.

The creative element addition module 130 receives as input the captured image 105 and the outputs of the image segmentation module 136 and the marker detection module 138. The creative element addition module 130 produces data to be used as input to the 3D rendering engine 146. The creative element addition module 130 selects a creative element 145 to insert in the captured image 105 based on the metadata 104 associated with the captured image 105.

The creative element addition system 120 also includes a creative element store 142. The creative element store 142 can be a database that contains a three-dimensional (3D) model of a creative element 145 that can be added to the captured image 105 in the media file 102. In an embodiment, the metadata 104 includes information that identifies the appropriate creative element 145 that is to be added to the captured image 105. For example, a creative element 145 can be added to every captured image 105 whose metadata 104 identifies a particular geographical location. In this manner, the creative element 145 is associated with that particular geographical location. Alternatively, a creative element 145 can be added to a captured image 105 based on the contents of the metadata 104, which may or may not include a unique identifier 107. The creative element store 142 is coupled to the 3D rendering engine 146 over connection 144. However, the creative element store 142 can be located remote from the creative element addition system 120 and can be accessible over a wide area or a local area network.

The 3D rendering engine 146 receives the output of the creative element addition module 130 and renders a 3D model of the creative element 145 along with any shadow cast by the creative element 145. The simulated lighting used by the 3D rendering engine 146 is determined by the direction and angle of the lighting cast on the marker 106 determined by the light analysis module 132 and the shadow analysis module 134, or as determined by metadata relative to the geographic location of the subject 103 and the time of day when the captured image 105 was captured.

The position and orientation of the creative element 145 is determined from the data provided by the creative element addition module 130, which determines it from the results provided by the image segmentation module 136 and the position and orientation of the marker 106 within the captured image 105 determined by the marker detection module 138. The 3D rendering engine 146 provides an output containing the rendered three dimensional creative element 145 over connection 148 to a compositor 152.

The compositor 152 receives the output of the 3D rendering engine 146 and performs an image overlay operation, combining the rendered 3D creative element 145 and any shadow over the captured image 105. The resulting scene gives the appearance that the additional creative element 145 matches the lighting characteristics and angle of other primary elements in the scene.

The compositor 152 determines position and orientation, and inserts the 3D model of the creative element 145 into the captured image 105 based on the characteristics of the marker 106 provided by the marker detection element 138, the light analysis module 132 and the shadow analysis module 134. The compositor 152 provides a revised media file 156 over connection 154. The revised media file 156 includes, in this embodiment, a creative element 145 added to the captured image 105.

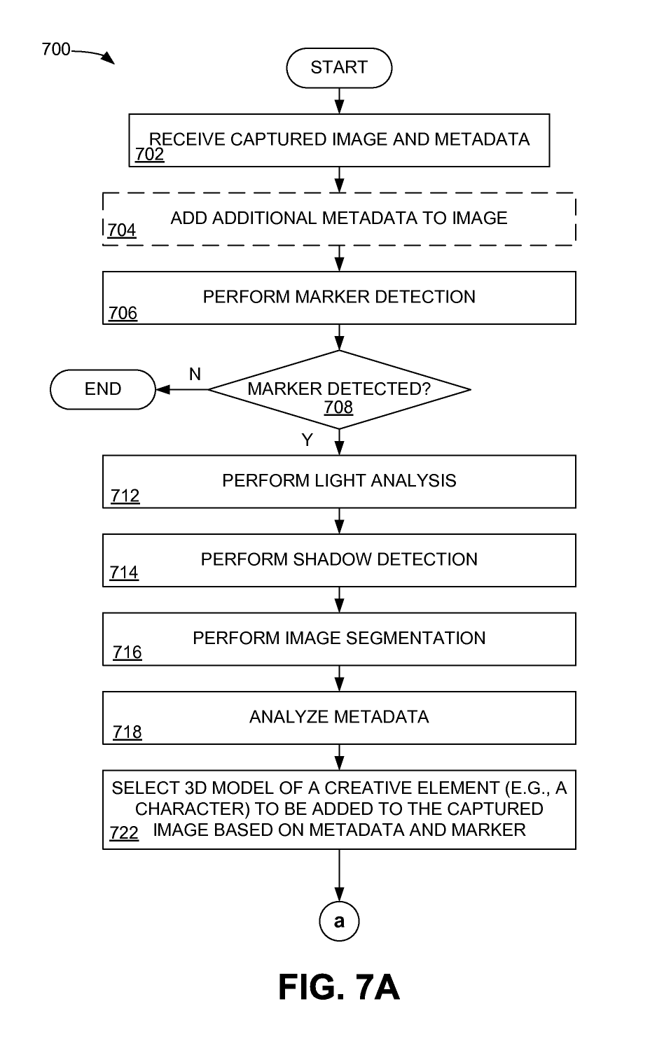

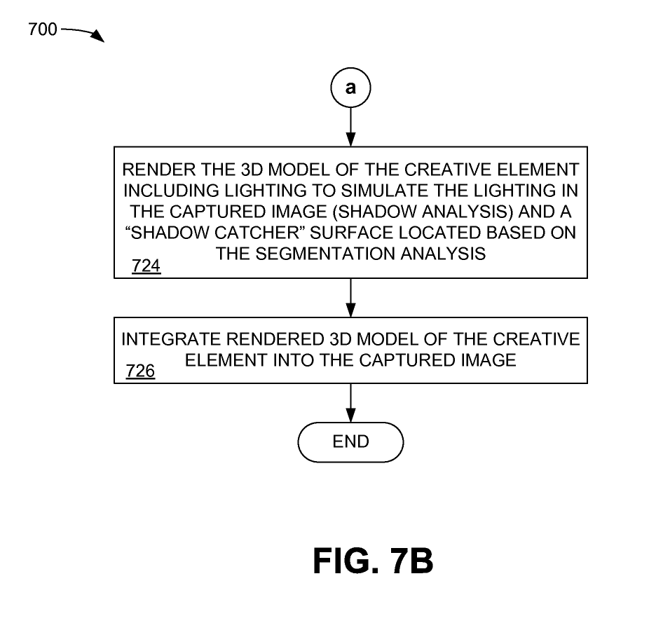

FIGS. 7A and 7B are a flowchart 700 collectively describing the operation of an embodiment of the creative element addition system 120 of FIG. 1. In block 702, the creative element addition system 120 receives the media file 102 containing the captured image 105 and the metadata 104 over connection 108. In block 704, additional metadata 104 can be optionally added to the captured image 105. For example, data in addition to the content forming the captured image 105 and metadata 104 can be appended to, prepended to, prefixed to, stored with, or otherwise associated with the captured image 105. As a basic example, the date and time that an image is captured is often associated with an image file that is captured with a digital camera. The date and time information is stored as metadata 104 along with the image file as a captured image 105 on a memory device associated with the digital camera. Additional data, such as GPS coordinates and compass direction information can also be stored as metadata 104. As an example, the creative element addition system 120 can generate information relating to the location of the sun with respect to an image captured out of doors using the date/time, GPS coordinates and compass direction. Additional data defined by a unique identifier 107 may be added to the media file 102 as additional metadata.

In bock 706, the marker detection module 138 receives as input the captured image 105 and uses a pattern-matching and feature detection algorithm to identify a marker 106 within the captured image 105. The marker detection module 138 searches the captured image 105 for the presence of the marker 106. The marker 106 can be an element added to the scene in the captured image 105, or it can be any object or part of the scene within the captured image 105. The metadata 104 identifies the marker 106. The marker detection module 138 may be implemented using one of a number of known processes for detecting an object in an image. For arbitrary, non-face objects, one or more “significant” features, such as straight edges, chords or arcs, 90 degree angles, perpendicular borders between straight edges, etc., are located in the captured image 105 and the marker 106 is identified.

In block 708, it is determined whether the marker 106 is identified. If the marker 106 is not identified, the process ends. If the marker 106 is identified, the marker detection module 138 provides as output the identity of the detected marker, and a bounding polygon 215 defining the area within the captured image 105 showing the location of the marker 106.

In block 712, the light analysis module 132 performs light analysis on the captured image 105 to attempt to detect the location of any light source in the captured image 105. The light analysis module 132 receives as input the media file 102, the bounding polygon 215 that locates the marker 106 in the captured image 105, and the identity of the located marker 106. The light analysis module 132 outputs a location 310 on a hemisphere 305. The location 310 illustrates a location on the hemisphere 305 where the effects of an illumination point source 312 can be applied when rendering the three-dimensional object of the creative element 145 that is to be placed within the captured image 105.

In block 714, the shadow analysis module 134 receives as input the media file 102, the bounding polygon 215 that locates the marker 106 in the captured image 105, and the identity of the located marker 106. The shadow analysis module 134 outputs the location 310 on the hemisphere 305. The location 310 illustrates a location where the effects of an illumination point source 312 can be applied when rendering the three-dimensional object of the creative element 145 that is to be placed within the captured image 105.

Although not specifically limited, shadow analysis is generally applicable to outdoor images where the presumption can be made that there is a single light source that is sufficiently far from the marker 106 so as to be considered an “infinite” distance from the marker 106. The shadow analysis module 134 searches for shadows in a captured image 105 by comparing the lighting of the marker 106 under evenly lit conditions (e.g., in a reference scene) to the actual scene in the captured image 105, or can globally examine the entire scene in the captured image.

In cases where the light source cannot be determined or where the metadata 104 indicates that the captured image 105 is an indoor/artificially lit image, the system may not render a shadow with the added creative element. In other instances, a shadow may not be rendered for other reasons, such as instances when a shadow would be unseen.

In block 716, the image segmentation module 136 determines three-dimensional structure for the scene depicted in the captured image 105. The image segmentation module 136 receives as input the output of the marker detection module 138 and the original captured image 105. The image segmentation module 136 makes assumptions based on the usage defined for the marker 106. For example, if the marker 106 is apparently located on the ground in the captured image 105, the image segmentation module 136 assumes the plane 320 (FIG. 3) that the marker 106 is on is the ground. If the marker 106 is intended for a vertical surface, the image segmentation module 136 assumes the marker 106 is perpendicular to the ground. Once the ground surface has been identified, a shadow plane 405 (FIG. 4) is rendered along with the three-dimensional object to be inserted to the scene. The shadow plane 405 can be composited to the ground surface in the original two-dimensional image so that a shadow cast by the rendered three-dimensional object of the creative element 145 appears to be an integral part of the captured image 105. The information about the “ground” can be expressed using the angles α, β, and γ as described above.

The orientation is established from the marker 106. The orientation of the marker 106 can be determined by calculating a geometric difference between the position of the marker when viewed from above and the position of the marker when viewed from a position orthogonal to the above view. Knowing that the marker is located on the ground plane 320 (FIG. 3) and knowing the position of the marker 106 allows the computation of α, β and γ based on the marker's orientation. This information allows the image segmentation module 136 to provide data relating to the orientation of the detected marker 106

In block 718, the creative element addition module 130 analyzes the metadata 104 to determine which creative element 145 to add to the captured image 105. In block 722, the creative element addition module 130 receives as input the captured image 105 and the outputs of the image segmentation module 136 and the marker detection module 138. The creative element addition module 130 produces data to be used as input to the 3D rendering engine 146. The creative element addition module 130 selects a creative element 145 to insert in the captured image 105 based on the metadata 104 associated with the captured image 105, the identity of the marker 106, and the location of the marker within the captured image 105.

The creative element store 142 may contain, for example, a three-dimensional model of an animated character that can be selected at least partially based on the metadata 104 associated with the captured image 105. The creative element 145 is selected based on metadata 104 that may include the geographic location depicted in the captured image 105, information added to the captured image 105 at the time of capture, or information determined by analyzing all available metadata 104 including location, time, GPS coordinates, compass heading, subject, photographer preferences, guest preferences and other factors.

In block 724, the 3D rendering engine 146 receives the output of the creative element addition module 130 and renders a three-dimensional model of the creative element 145 along with any shadow cast by the creative element 145. The simulated lighting used in by the 3D rendering engine 146 is determined by the direction and angle of the lighting cast on the marker 106 deduced by the light analysis module 132 and the shadow analysis module 134. The position and orientation of the creative element 145 is determined from the data provided by the creative element addition module 130, which computes the position and orientation from the output provided by the image segmentation module 136 and the position and orientation of the marker 106 within the captured image 105 determined by the marker detection module 138. The 3D rendering engine 146 provides an output containing the rendered three-dimensional creative element 145 over connection 148 to a compositor 152.

In block 726, the compositor 152 receives the output of the 3D rendering engine 146 and performs an image overlay operation, combining the rendered three-dimensional creative element 145 and its shadow over the captured image 105. The resulting scene gives the appearance that the additional creative element 145 matches the lighting characteristics and angle of other primary elements in the scene.

The compositor 152 scales, positions, determines relative location and composites the three-dimensional model of the creative element 145 onto the captured image 105 based on the characteristics of the marker 106 provided by the marker detection element 138, the light analysis module 132 and the shadow analysis module 134. The compositor 152 provides a revised media file 156 (FIG. 1) over connection 154. The revised media file 156 includes, in this embodiment, a creative element 145 added to the captured image 105.

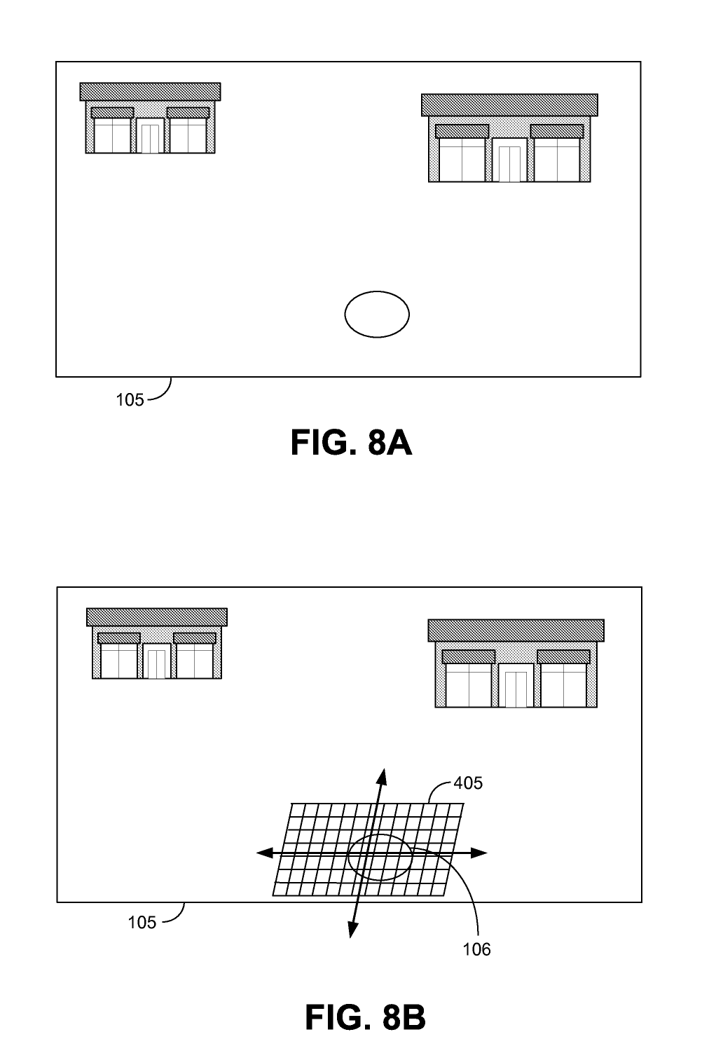

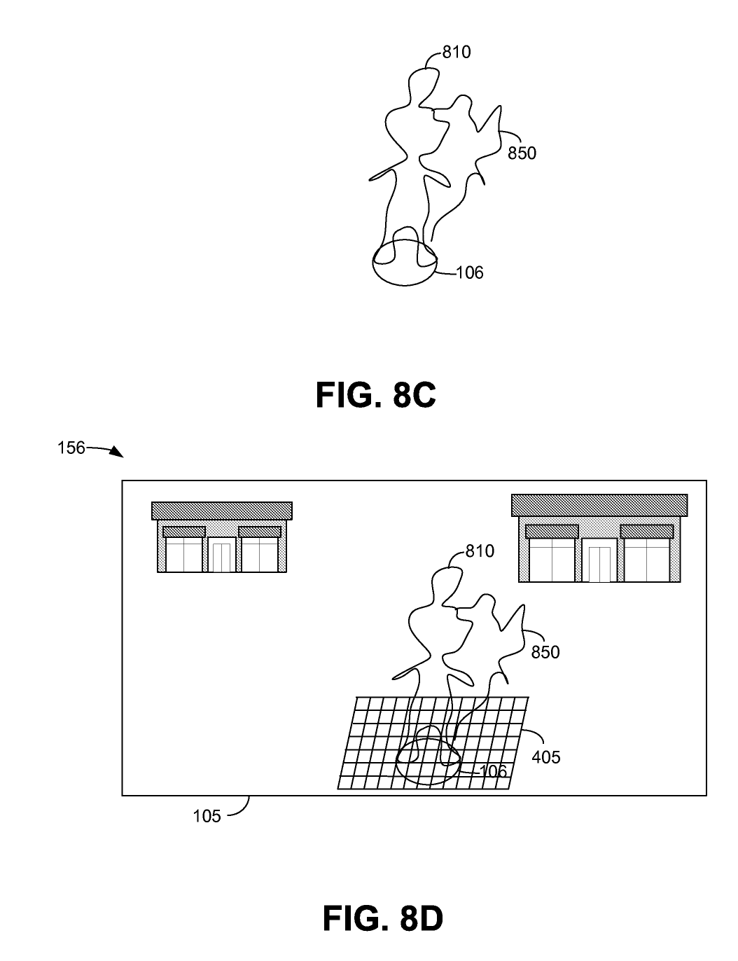

FIGS. 8A through 8D collectively illustrate a graphical representation showing the operation of an embodiment of the system and method for adding a creative element to media. FIG. 8A shows an example of a captured image 105. The captured image 105 includes a street scene.

FIG. 8B illustrates a feature in the captured image 105 being used as a marker 106. The marker 106 is identified within the captured image 105 by the marker detection module 138. In this example, the marker detection module 138 has identified a manhole cover in the captured image 105 as the marker 106. However, other elements or features within the captured image 105 could be identified as the marker 106. A shadow plane 405 is shown overlaid on the captured image 105.

FIG. 8C illustrates an example of a three-dimensional creative element 810 rendered by the 3D rendering engine 146. The 3D rendering engine 146 receives a creative element 145 from the creative element store 142 and develops a rendering 810 of the three-dimensional creative element. In an embodiment, the rendering 810 includes a shadow 850. The shadow 850 is developed by the light analysis module 132 and the shadow analysis module 134 after determining the lighting and shadow direction in the captured image 105. Alternatively, metadata comprising the geographic location of the subject when the content was captured and the time of day that the content was captured can be used to determine the lighting and shadow applied to the three-dimensional rendering of the creative element.

The marker 106 is used as a reference in FIG. 8C to locate the rendered creative element 810 and the shadow 850. The creative element 145 is sized and scaled based on the relative dimensions of the marker 106.

In FIG. 8D the rendered creative element 810 has been added to the captured image 105 resulting in a revised image 156 that shows the rendered creative element 810, including the shadow 850 and the marker 106 located in the captured image 105. Although the shadow plane 405 is shown in FIG. 8D, it would normally not be present in the revised image 156.

It is likely that the captured image 105 will be taken at established locations at known times. Therefore, it is possible to reduce the set of possible lighting conditions to those produced by the sun's known position in the sky. The captured image 105 will still be analyzed automatically to avoid rendering a shadow if none is detected on the marker 106 (i.e., if the sky is overcast), and to compensate for variations in the photographer's position and angle.

While various embodiments of the invention have been described, it will be apparent to those of ordinary skill in the art that many more embodiments and implementations are possible that are within the scope of the invention.

What is claimed is:

1. A system for adding a creative element to media, comprising:
a media file having content and metadata associated with the content;
logic for analyzing the content to determine at least one of a lighting characteristic, a shadow characteristic, and a presence of an identifying element associated with the content;
a creative element store configured to store at least one creative element;
a rendering engine configured to develop a three dimensional rendering of the creative element, the three dimensional rendering including at least one of the lighting characteristic and the shadow characteristic; and
a compositor configured to add the three dimensional rendering of the creative element into the content based on the metadata.

2. The system of claim 1, wherein the metadata identifies at least one characteristic of the content.

3. The system of claim 1, wherein the identifying element is a marker that is part of a scene that is captured to generate the content.

4. The system of claim 1, wherein the identifying element is a marker that is added to a scene that is captured to generate the content.

5. The system of claim 1, wherein the three-dimensional rendering of the creative element is added to the content from a perspective of a virtual camera viewing a subject in the content such that an appearance of the three-dimensional rendering of the creative element matches an appearance of the subject.

6. The system of claim 5, wherein the virtual camera is positioned based on at least one of a detected position, rotation, and orientation of the identifying element associated with the content.

7. The system of claim 5, wherein the three-dimensional rendering of the creative element includes lighting that matches a lighting of the subject.

8. A method for adding a creative element to media, comprising:
receiving a media file having content and metadata associated with the content;
analyzing the content to determine at least one of a lighting characteristic, a shadow characteristic, and a presence of an identifying element associated with the content;
storing at least one creative element;
choosing the at least one creative element based on the metadata;
developing a three dimensional rendering of the creative element, the three dimensional rendering including at least one of the lighting characteristic and the shadow characteristic; and
adding the three dimensional rendering of the creative element into the content.

9. The method of claim 8, further comprising using the metadata to identify at least one characteristic of the content.

10. The method of claim 8, wherein the identifying element is a marker that is part of a scene that is captured to generate the content.

11. The method of claim 8, wherein the identifying element is a marker that is added to a scene that is captured to generate the content.

12. The method of claim 8, further comprising adding the three-dimensional rendering of the creative element to the content from a perspective of a virtual camera viewing a subject in the content such that an appearance of the three-dimensional rendering of the creative element matches an appearance of the subject.

13. The method of claim 12, further comprising positioning the virtual camera based on at least one of a detected position, rotation and orientation of the identifying element associated with the content.

14. The method of claim 12, wherein the three-dimensional rendering of the creative element includes lighting that matches a lighting of the subject.

15. The method of claim 14, wherein the lighting applied to the three-dimensional rendering of the creative element is determined based on the lighting of the subject.

16. The method of claim 14, wherein the lighting applied to the three-dimensional rendering of the creative element is determined based on metadata comprising the geographic location of the subject when the content was captured and the time of day that the content was captured.

17. A method for adding a creative element to media, comprising:
receiving a media file having content and metadata associated with the content;
analyzing the content to determine at least one of a lighting characteristic, a shadow characteristic, and a presence of an identifying element associated with the content;
storing at least one creative element;
choosing the at least one creative element based on the metadata and the identifying element;
developing a three dimensional rendering of the creative element, the three dimensional rendering including at least one of the lighting characteristic and the shadow characteristic; and
adding the three dimensional rendering of the creative element into the content from a perspective of a virtual camera viewing a subject in the content such that an appearance of the three-dimensional rendering of the creative element matches an appearance of the subject.

18. The method of claim 17, further comprising using the metadata to identify at least one characteristic of the content.

19. The method of claim 17, wherein the identifying element is a marker that is part of a scene that is captured to generate the content.

20. The method of claim 17, wherein the identifying element is a marker that is added to a scene that is captured to generate the content.

21. The method of claim 17, further comprising positioning the virtual camera based on at least one of a detected position, rotation and orientation of the identifying element associated with the content.

22. The method of claim 17, wherein the three-dimensional rendering of the creative element includes lighting that matches a lighting of the subject.

23. The method of claim 22, wherein the lighting applied to the three-dimensional rendering of the creative element is determined based on the lighting of the subject.

24. The method of claim 22, wherein the lighting applied to the three-dimensional rendering of the creative element is determined based on metadata comprising the geographic location of the subject when the content was captured and the time of day that the content was captured.
